(19) United States
(12) Patent Application Publication
(10) Pub. No.: US 2013/0182005 A1
(43) Pub. Date: Jul. 18, 2013

(54) VIRTUAL FASHION MIRROR SYSTEM

(71) Applicants: Lisa Fretwell, Leicester (GB); Clive Grinyer, London (GB)

(72) Inventors: Lisa Fretwell, Leicester (GB); Clive Grinyer, London (GB)

(73) Assignee: Cisco Technology, Inc., San Jose, CA (US)

(21) Appl. No.: 13/349,018

(22) Filed: Jan. 12, 2012

(51) Int. Cl. G09G 5/00

(52) U.S. Cl. 345/629

(57) ABSTRACT

In one embodiment, a method of calibrating an image on a virtual mirror display can include receiving a moving image of a body. The method can include generating display of a left image overlay and a right image overlay. The method can include displaying the captured image of the body and the left and right image overlay on the virtual mirror. The method can include detecting alignment of a location of a left hand with the left image overlay and a location of a right hand with the right image overlay. The method can include establishing at least one reference location on the captured image of the body corresponding to at least one location of the image of the body.

### TECHNICAL FIELD

The present embodiments relate to a system for calibrating an image on a display.

### BACKGROUND

A graphical user interface (GUI) may enable a user to interact with an electronic device through a series of graphical icons or other visual indicators. The user may issue commands to the electronic device by manipulating the graphical elements of the GUI. Such manipulation generally may be accomplished with a pointing device such as a mouse, a trackball, a joystick, a pointing stick, a touchpad, or a touchscreen. The user may manipulate the pointing device to cause a corresponding movement of a pointer or a cursor on the GUI.

### BRIEF DESCRIPTION OF THE DRAWINGS

FIG. 1 illustrates one embodiment of an imaging system;

FIG. 2 illustrates one embodiment of a server application of the imaging system of FIG. 1;

FIG. 3 is a flow chart illustrating one example of a method of operating the imaging system of FIG. 1;

FIG. 4 is one example of a graphical user interface which may be displayed on a display device of the imaging system of FIG. 1; and

FIG. 5 is a flow chart illustrating one example of a method of calibration on a display device.

### DETAILED DESCRIPTION OF THE DRAWINGS

### Overview

In one embodiment, a method of calibrating an image on a virtual mirror display can include receiving a moving image of a body. The method can include generating display of a left image overlay and a right image overlay. The method can include displaying the captured image of the body and the left and right image overly on the virtual mirror. The method can include detecting alignment of a location of a left hand with the left image overlay and a location of a right hand with the right image overlay. The method can include establishing at least one reference location on the captured image of the body corresponding to at least one location of the image of the body.

In another embodiment, a system can include a memory including a plurality of modules and a processor configured to execute the plurality of modules. The system can include an image module configured to receive a moving image of a body from an image capture device. The system can include an image overlay module configured to generate display of a left image overlay and a right image overlay. The system can include a display module configured to display the captured image of the body and the left image overlay and the right image overlay on the virtual mirror. The system may include a hand detection module configured to detect alignment of a location of a left hand with the left image overlay and a location of a right hand with the right image overlay. The system can include a calibration module configured to establish at least one reference location on the captured image of the body corresponding to at least one location of the image of the body.

In yet another embodiment, a computer readable medium can be encoded with computer executable instructions executable with a processor. The computer readable medium can include instructions executable to receive a moving image of a body generating display of a left image overlay and a right image overlay. The computer readable medium can include instructions executable to display the captured image of the body and the left and right image overlay on the virtual mirror. The computer readable medium can include instructions executable to detect alignment of a location of a left hand with the left image overlay and a location of a right hand with the right image overlay. The computer readable medium can include instructions executable to establish at least one reference location on the captured image of the body corresponding to at least one location of the image of the body.

### EXAMPLE EMBODIMENTS

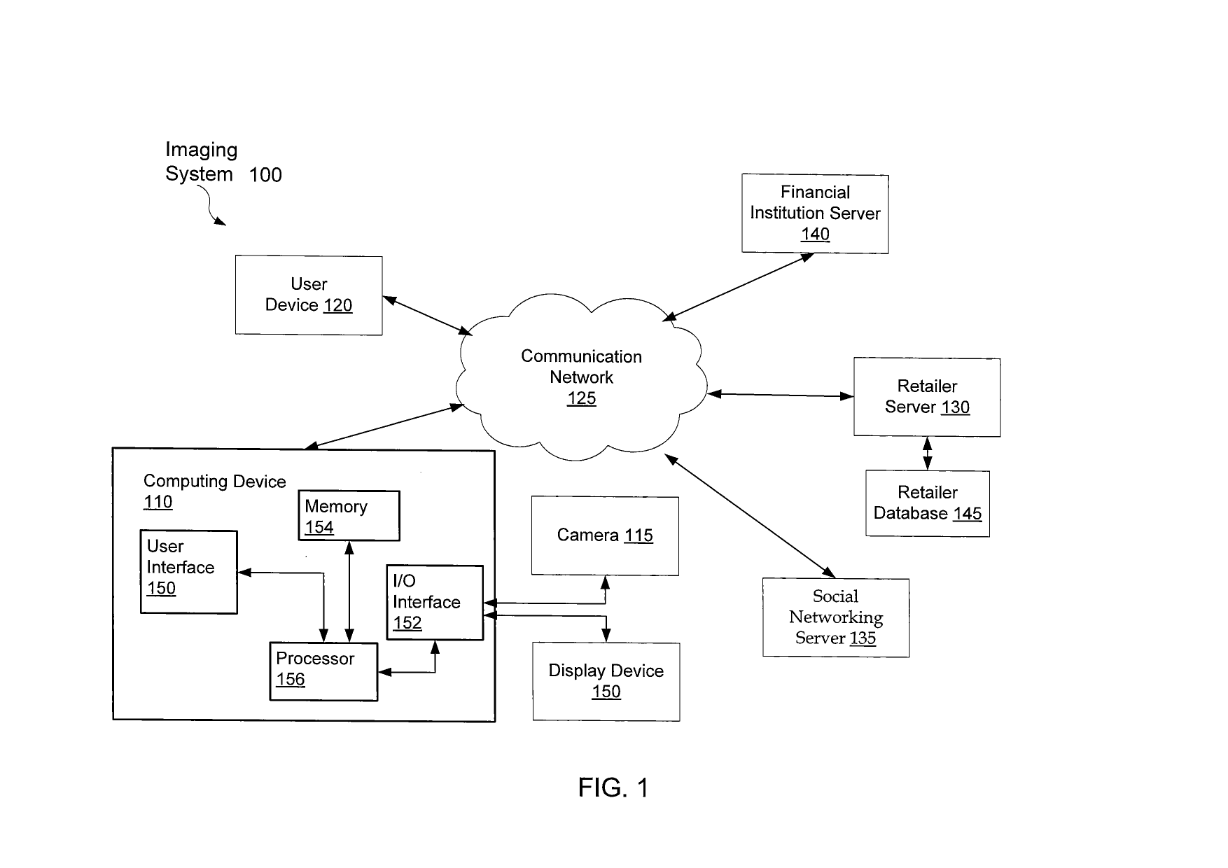

FIG. 1 is a schematic view of an imaging system 100 in accordance with some embodiments. In one example, the imaging system 100 may include a computing device 110, a camera 115, a user device 120, a retailer server 130, a retailer database 145, a financial institution server 140, and a social networking server 135. The various devices and servers described herein may be connected to a communication network 125 in any suitable manner including, for example, any wired or wireless connection using any network connection protocol.

The computing device 110 may be any type of computing device capable of establishing a networked connection and/or a peer-to-peer connection and capable of providing display, user interface, and/or input capabilities, as will be described in more detail below. The computing device 110 may be configured as, for example, a desktop computer, a personal computer (PC), a laptop computer, a palmtop computer, a handheld computer, a cellular telephone, a personal digital assistant (PDA), a computer workstation, a tablet PC, and the like.

The computing device 110 may include a user interface 150, a processor 156, a memory 154, and/or an input/output (I/O) interface 152. The user interface 150 may include buttons, sliders, knobs, a touch screen, or any other form of interface that allows user commands to be provided to the computing device 110. Additionally, or alternatively, the user interface 150 may include any form of audio and/or visual outputs for receipt by a user of the computing device 110. The audio and/or visual outputs of the user interface 150 may include, for example, a light emitting diode (LED), a meter, a display, such as a liquid crystal display (LCD), or any other mechanism providing indication to a user of the condition and/or operation of the computing device 110.

The processor 156 may be used to run operating system applications, firmware applications, media playback applications, media editing applications, or any other application. In some embodiments, the processor 156 can drive a display and process inputs received from one or more input devices. The processor 156 may include one or more microprocessors, digital signal processors, field programmable gate arrays (FPGA), or any other mechanism or device capable of executing logic and/or processing input and output signals.

The memory 154 may be a volatile and/or a non-volatile memory device that is configured to store instructions executable by the processor 156. The memory 154 may include a medium that preserves data for retrieval, such as instructions retrieved for execution. The memory 154 may include a hard disk drive, a compact disc drive, a digital versatile disc drive, a Random Access Memory (RAM), a Read Only Memory (ROM), a Programmable Read-Only Memory (PROM), an Electrically Erasable Programmable Read-Only Memory (EEPROM), a flash memory, or any other digital storage device.

The computing device 110 may communicate with one or more input and/or output devices via the I/O interface 152. The input/output devices may include, for example, a keyboard (e.g., a hard keyboard or a soft keyboard), a mouse (e.g., a trackball, a rollerball, a touchpad, or other pointing device), a stylus or other pen-type input device (e.g., for a tablet PC type computing device), a disk drive, a USB port, a network connection, a joystick type controller, a telephone connection, an Ethernet connection, a voice recognition capability, or any other type of input/output devices. The input/output devices may also include, for example, a fax machine, a printer, a copier, an image and/or video display device (e.g., a television, a monitor, or a projector), an audio output device, or any other type of input/output devices.

The camera 115 may include any type of image capture device for capturing a moving image. For example, the camera may include a color and depth camera, a webcam, a charge coupled device (CCD) camera, a complementary metal oxide semiconductor (CMOS) camera, a 3D camera, or any other type of image capture device. The moving image may be captured and/or stored as image data. The image data may include a video. Alternatively, or additionally, the image data may include a series of still images that collectively define the moving image. The camera 115 may have a communication interface to communicate with the computing device 110 to exchange data, including image data. The camera 115 may transfer the image data and/or status information to the computing device 110. Additionally, or alternatively, the camera 115 may receive data from the computing device. For example, the camera may receive stored image data, instructions to perform a variety of tasks, or processing updates from the computing device 110. In one example, the camera 115 may be provided that is separate from the computing device 110. In another example, the camera 115 may be integral with the computing device 110 (e.g., an embedded webcam).

In another example, the camera 115 may include a communication interface to communicate with the retailer server 130 via the communication network 125 to exchange data, including image data. For example, the camera 115 may transfer image data and/or status information to the retailer server 130. Additionally, or alternatively, the camera 115 may receive data from the retailer server 130. For example, the camera 115 may receive stored image data, instructions to perform a variety of tasks, or processing updates from the retailer server 130.

In one example, a display device 150 may be provided for displaying an image captured by the camera 115. The display device 150 may be integral with or separate from the computing device 110. The display device 150 may be in communication with or may receive an input or signal from the camera 115. The display device 150 may be any suitable device operable to visually present information in an electronic form. For example, the display device 150 may present dynamic and/or static images such as video, text, photos, and graphical elements. The display device 150 may be a cathode ray tube (CRT) screen, a liquid crystal display (LCD), a plasma display panel (PDP), a field emission display (FED), an analog or digital projection, or any other type of display. In one example, the display device 150 may be configured as a shopper display through which a user (e.g., a consumer) may interact with the imaging system 100.

In one example, the display device 150 may display a graphical user interface (GUI) that enables the user of the interface to interact with at least a portion of the imaging system 100 for any suitable purpose. The display device 150 may provide the user with an efficient and user-friendly presentation of data provided by the imaging system 100. The display device 150 may include customizable frames or views having interactive fields, pull-down lists, and/or buttons operated by the user. The display device 150 may be a touch screen, and the GUI may be part of the display device. Depending on the type of touch screen, a user may interact with the touch screen with a touch of the user's finger or by touching the screen with a stylus.

In one example, the imaging system 100 may include the retailer server 130. The retailer server 130 may be located in a retail store location or may be located remote from the retail store location. The retailer server 130 may be connected to the communication network 125 in any desired manner including, for example, a wired or wireless connection using any network connection protocol. The retailer server 130 may be the control computer for a point of sale system for a retail store or a chain of retail stores.

The retailer server 130 can include any processor or processing circuitry operative to control the operations and performance of the imaging system 100. For example, processor can be used to run operating system applications, firmware applications, media playback applications, media editing applications, or any other application. In some embodiments, the processor can run a server application to drive a display and process inputs received from the computing device 110 and/or the user device 120.

The retailer server 130 may interact with the retailer database 145. The retailer database 145 can include, for example, one or more storage mediums including a hard-drive, solid state drive, flash memory, permanent memory such as read-only memory (ROM), any other suitable type of storage component, or any combination thereof. The retailer database 145 can store, for example, media data (e.g., music and video files and photos), application data (e.g., for implementing functions), firmware, authentication information (e.g., libraries of data associated with authorized users), user profile and lifestyle data (e.g., user preferences, age, and gender), transaction information data (e.g., information such as credit card information), wireless connection information data, contact information data (e.g., telephone numbers and email addresses), calendar information data, inventory data (e.g., data related to each product offered at a retail store or a chain of retail stores including an indication of availability for each product), any other suitable data, or any combination thereof.

In one example, the user device 120 can include any suitable type of electronic device. For example, the user device 120 may include a portable electronic device that may be held in the user's hand, such as a tablet PC, a smart phone, a personal data assistant (PDA), a cellular telephone, or the like. The user device 120 may include a user interface. The user interface on the user device 120 may be provided and controlled by one or more of the computing device 110 and/or the retailer server 130. Data for generating, maintaining, and receiving input through the user interface may be generated and provided via a computer readable media included as part of or associated with one or more of the computing device 110 and/or the retail server 130. Examples of such computer readable media may include, but are not limited to computer-readable memories, both internal to a computer (e.g., hard drives) or separable from the computer (such as disks, solid state or flash memory devices, data available over a networked connection, etc.).

The user interface of the user device 120 may be used to complete a registration and/or login process. The user registration and/or login process can be tailored to the needs of the embodiment. In one embodiment of the user registration and/or login process, a user may login and/or register for a user account using a social networking account (e.g., Facebook, Twitter, etc.). For example, the retailer may allow a new user to register a new user account with the retailer using a social networking account. Typically, a social networking site may provide the retailer with a registration program, such as a plugin, which enables a user to easily sign up at the retailer website with the user's social networking account. Allowing a user to login and/or register using a valid social networking account may help to validate the user's identity. This also may enable information (e.g., information regarding how to obtain and/or change a password) to be sent to the user, which may provide an additional layer of security. Additionally, or alternatively, it may enable the user to easily share information with others using the social networking account via the social networking server 135.

In another example, the user may be prompted to create or provide a password, a username, and/or authentication information, which may not be associated with a social networking account. Alternatively, the user may be allowed to sign in as a guest without being required to register or provide any personal information. In other examples, user input may not be required at all to gain access.

In another example, the user device 120 can include a portable electronic device, such as a laptop computer. In yet another example, the user device 120 can include a substantially fixed electronic device, such as a desktop computer. In another example, the user device 120 may be omitted from the imaging system 100. In this example, the user may registered and/or login in to the imaging system 100 using the computing device 110.

In one example, the imaging system 100 may include the financial institution server 140. When processing an e-commerce transaction, the retailer server 130 may communicate with the financial institution server 140 to determine whether sufficient funds exist for the desired secure e-commerce transaction. Such communication may be between the retailer server 130 and the financial institution server 140 via a dedicated, or virtually dedicated, private and secure communication path via the communication network 125. The data exchanged between the retailer server 130 and the financial institution server 140 may be clear data and/or encrypted.

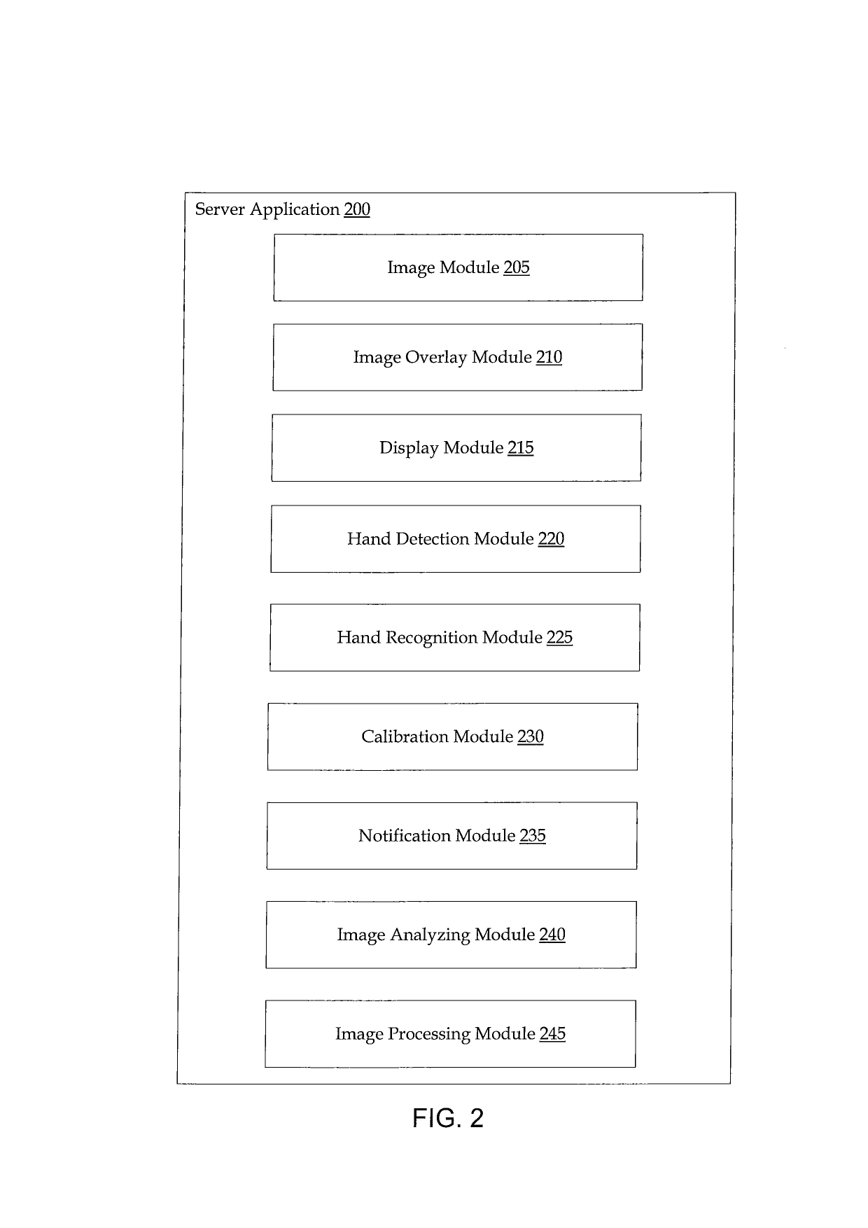

Referring now to FIG. 2, a block diagram illustrating the components of a server application 200 is shown in an exemplary embodiment. The modules that are described herein are described for purposes of example as separate modules to illustrate functionalities that are provided by the respective server application 200. The server application 200 in an exemplary embodiment has associated with it an image module 205, an image overlay module 210, a display module 215, a hand detection module 220, a calibration module 225, a hand recognition module 230, a notification module 235, and an image analyzing module 240. The server application 200 may interact with retailer database 145. The server application 200 may be stored on or executable from the retailer server 130, the computing device 110, any other device, or any combination thereof. The server application 200 may interact with the retailer database 145.

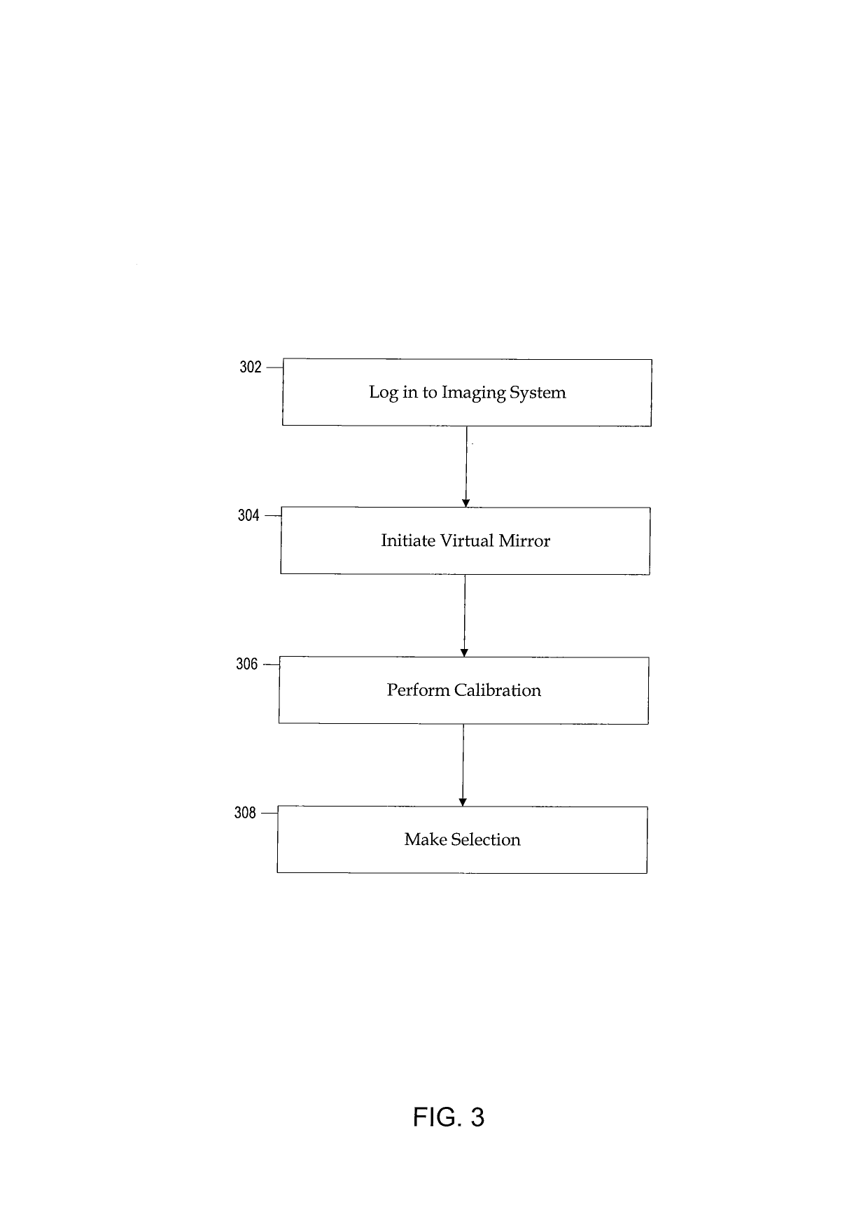

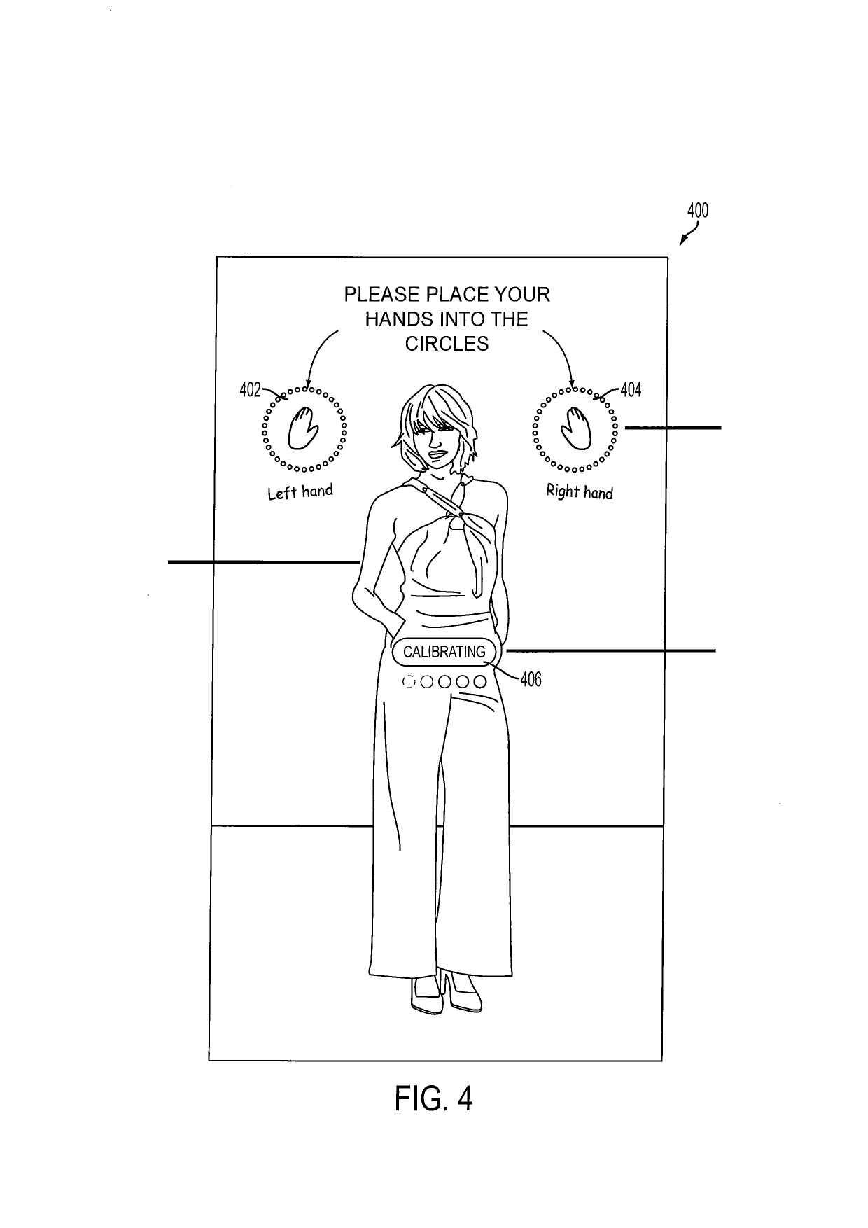

In one embodiment, the imaging system 100 may be configured to function as a virtual mirror, which may enable a user to virtually try on an article of clothing. FIG. 3 illustrates one embodiment of a method of operating the imaging system 100. The user may log in to the imaging system 100 at step 302. The user may log in using the user device 120, the computing device 110, or any other suitable device. The user may log in with a username and/or password associated with the imaging system 100 (e.g., a retailer account), a social networking account, or any other login information. A virtual mirror process may be initiated at step 304. The user may initiate the virtual mirror process by, for example, standing in front of the camera 115, waving the user's hands in front of the camera 115, or activating an appropriate input to the computing device 110. Upon initiation of the virtual mirror process, the computing device 110 may recognize the presence of the user in front of the camera 115. A GUI may be displayed on the display device 150. FIG. 4 illustrates one example of the GUI 400, which may be displayed on the display device 150. The user may interact with the GUI 400 as further described below.

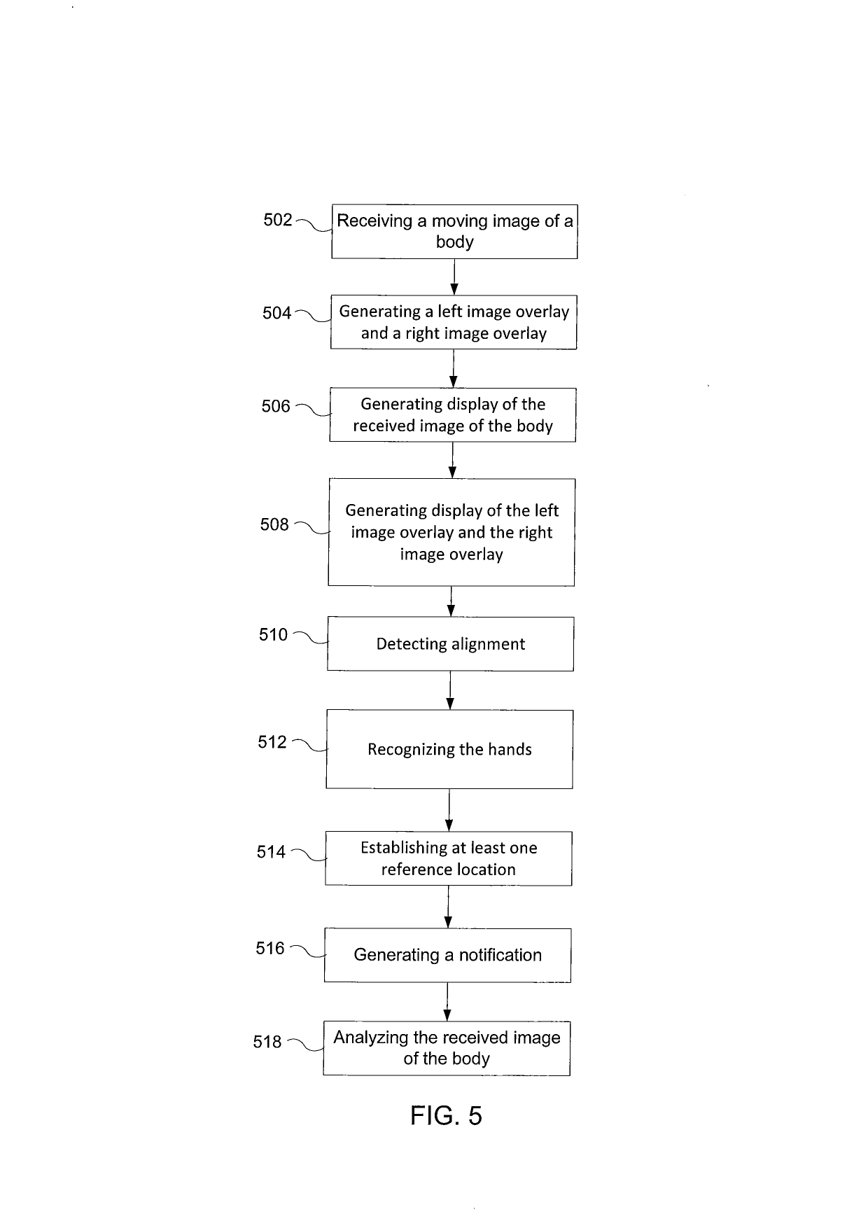

Returning to FIG. 3, a calibration process may be performed at step 306. FIG. 5 illustrates a series of steps which may be performed for the calibration to be completed. The calibration process may enable the imaging system to locate or identify various points of the user's body so that the user may manipulate or control the imaging system as described below. The calibration process may include establishing at least one reference location on the captured image of the body corresponding to at least one location of the image of the body. The calibration process may further include analyzing an image of the body of the user. The user may be requested to stand in a predefined position relative to the camera 115. A moving image of a body of the user may be received at step 502. The moving image of the body may be captured by the camera 115 as described above. The moving image may be transmitted by the camera 115 for receipt by the image module 205.

During calibration, the user may be requested to stand with the user's arms raised, and the user's hands at predefined positions. The user may be guided into the predefined position by visual indicators displayed with the image of the user on the display device. In one example, the user may be requested to stand such that each of the user's hands in the image of the user is positioned within an identified portion of the display device to enable the imaging system 100 to locate or identify each of the user's hands. For example, a left image overlay 402 and a right image overlay 404 may be generated at step 504. The image overlays may be generated by the image overlay module 210. Each overlay may be a predetermined shape. For example, each overlay may be a circle. The circle may be a dotted circle having a transparent core. The circle may have a predetermined diameter configured to surround one of the first and second portions of the image of the body. In other examples, the predetermined shape may be a triangle, a square, an ellipse, or any other polygonal or non-polygonal shape.

During calibration, the moving image may be displayed on the display device 150 by the display module 215 at step 506. The left image overlay 402 and the right image overlay 404 may be displayed on the display device 150 by the display module 215 at step 508. In one example, the predefined positions of the left image overlay 402 and right image overlay 404 on the display device 150 may be determined based on at least one attribute of the captured image of the body. For example, the predefined positions of the left image overlay 402 and right image overlay 404 on the display device 150 may be based on the height of the user.

Alignment of a location of a first portion of the captured image of the body with the left image overlay 402 and a location of a second portion of the captured image of the body with the right image overlay 404 may be detected at step 510 as shown in FIG. 5. Such alignment may be detected by the hand detection module 220. The alignment process may enable the imaging system 100 to locate or identify a location of the first and second portion of the captured image of the body.

Upon alignment, the hand recognition module 225 may identify each of the user's hands at step 512. A reference location of a first portion and a second portion in the received image may be established at step 514. A reference location for a first portion and a second portion of the captured image of the body may be established by the calibration module 230. For example, a reference location for the left hand of the user, a reference location of the right hand of the user, or reference locations for both of the left hand and the right hand may be established. Established reference locations may be used to track movement of the locations of portions of the body in the received image. The establishment of at least one reference location may be made in response to passage of a predetermined time. In one example, the predetermined time may be 2 seconds. In other examples, the predetermined time may be any length of time. Additional or alternative reference locations may be established on the captured image to define where body joints (e.g., elbows, knees, etc.) and other garment measurement points are on the user. The reference points may enable the generation of an accurate depiction of the clothes superimposed on the captured image of the body. The reference points may enable determination of certain lengths, widths, and heights for generating the superimposed clothing. In some embodiments, other data points or structures defining the captured image of the body may be used to size and display a selected clothing article on the appropriate part of the captured image of the body. For example, reference points associated with the shoulders, elbows, wrists, and waist may be established in order to superimpose a selected shirt on the captured image of the body.

At step 516, the notification module 235 may generate a notification in response to the establishment of at least one reference location as described above. The notification may include a visual notification, an audible notification, a tactile notification, or any other type of notification that may be perceptible by the user. The notification may provide an indication to the user that the calibration process is complete. The notification module 235 may generate guidance information to the user when at least one reference point cannot be established. For example, the notification module 235 may guide the user to remain motionless in the image overlays until the calibration process is complete. Alternatively or in addition, a message may be displayed on the display device 150 while the calibration process is in progress. For example, a “calibrating” message 406 may be displayed on display device 150.

As described above, the left image overlay 402 and right image overlay 404 may be a predetermined shape. Generating the notification may include changing at least one attribute of each image overlay. For example, one attribute of the each overlay may be changed in response to a length of time that each hand is aligned with the respective image overlay. In other words, at least one attribute of the predetermined shape may change as a function of the amount of time that each hand remains motionless within the respective image overlay. The attribute may include, for example, a color, a brightness, a transparency, a shape, a size, or any other attribute of the predetermined shape.

For example, each image overlay may be a transparent, dotted circle as shown in FIG. 4. Each circle may be filled with a color (e.g., green) in response to the length of time that each hand is aligned with the respective image overlay. The portion of the circle that is filled with the color may be representative of the portion of the predetermined time that has elapsed before calibration is to occur. For example, if 30% of the predetermined time has elapsed, 30% of the inner portion of the circle may be filled with the color, and the remaining 70% of the circle may be transparent. The calibration process may be complete when the circle becomes completely filled with the color.

Referring back to FIG. 3, a selection may be made at step 308. For example, the user may select a selectable image overlay displayed on the display device 150 as part of the GUI 400 to navigate to one or more menus, to navigate to one or more browsable lists, to select one of a variety of different menu options, to select an item from a selectable list of items, or to select an article of clothing that the user wishes to try on using the virtual mirror. The selectable image overlays may be generated by the image overlay module 210. The selectable image overlays may include buttons, sliders, knobs, a touch screen, or any other form of interface that allows user commands to be provided to the computing device 110.

As described above, in one embodiment, the imaging system 100 may be configured to function as a virtual mirror which may enable a user to virtually try on an article of clothing. To that end, the GUI 400 may include a selectable object configured as a show me selectable object and/or a hide me selectable object. For example, the GUI 400 may include show me and/or hide me buttons, a dropdown list with show me and/or hide me options, or any other type of selectable object that may enable the user to select show me and/or hide me. Upon selection of the show me selectable object, the moving image of the user as captured by a camera may be displayed on the display device 150. In other words, a live reflection of the user may be displayed on the display device 150 such that the display device 150 may function as a virtual mirror display. The image processing module 245 may apply at least one virtual modification to the captured image. For example, upon selection of an article of clothing to virtually try on, a stored image of the article of clothing may be superimposed over the moving image such that the user appears to be wearing the selected article of clothing. The displayed article of clothing may move on the display device 150 to correspond with movement of the user in the moving image. Upon selection of the hide me selectable object, the moving image of the user may be hidden (i.e., may be invisible) on the display device 150. In other words, the live reflection of the user may be hidden. The GUI 400 may be displayed on the display device with or without the moving image.

Referring again to FIG. 5, the image analyzing module 240 may analyze the received image of the body to obtain at least one attribute associated with the image of the body at step 518. For example, the image analyzing module 240 may determine the outline of the image of the body. Using the determined outline of the image of the body, the image processing module 245 may trim at least one edge of the captured image of the body. Trimming refers to the removal of the outer parts of the captured image of the body. A predetermined percentage of the edge may be trimmed in an attempt to hide the clothes actually being worn by the user behind the superimposed clothing images. In one example, a default percentage may be used. Alternatively or in addition, an adjustable percentage may be used based on the type of clothing being worn by the user. For example, a user wearing baggy clothing may need to have a higher percentage of the captured image of the body trimmed than someone wearing tight-fitting clothing so that the baggy clothing does not “stick out” from under the superimposed clothing articles.

Various embodiments described herein can be used alone or in combination with one another. The foregoing detailed description has described only a few of the many possible implementations of the present invention. For this reason, this detailed description is intended by way of illustration, and not by way of limitation.

1. An imaging system, comprising:
a server comprising a plurality of modules, and a processor configured to execute the plurality of modules;
an image module configured to receive a moving image of a body;
an image overlay module executable to generate a left image overlay and a right image overlay;
a display module executable to generate display of the received image of the body on a display device;
the display module further configured to generate display of the left image overlay and the right image overlay at a predetermined location on the display device;
a hand detection module executable to detect alignment of a location of a first portion of the image of the body with the left image overlay and a location of a second portion of the image of the body with the right image overlay after a predetermined amount of time; and
a calibration module executable to establish at least one reference location on the captured image of the body corresponding to at least one of the location of the first portion of the image of the body or the location of the second portion of the image of the body.

2. The imaging system of claim 1, further comprising a hand recognition module executable to recognize the first portion of the image of the body is a left hand of the body and the second portion of the image of the body is the right hand of the body.

3. The imaging system of claim 1, further comprising a notification module executable to generate a notification in response to at least one reference location being established.

4. The imaging system of claim 3, wherein the notification comprises a visual notification.

5. The imaging system of claim 3, wherein the notification comprises an audible notification.

6. The imaging system of claim 1, further comprising an image analyzing module executable to analyze the captured image of the body to obtain at least one attribute associated with the image of the body.

7. The imaging system of claim 1, wherein at least one of the left image overlay or the right image overlay is a circle with a predetermined diameter configured to surround one of the first and second portions of the image of the body.

8. The imaging system of claim 1, further comprising an image processing module executable to apply at least one virtual modification to the captured image.

9. The imaging system of claim 8, wherein the at least one virtual modification comprises trimming at least one edge of the captured image of the body.

10. The imaging system of claim 8, wherein the at least one virtual modification comprises superimposing additional visual information including at least one article of clothing onto the captured image of the body.

11. The imaging system of claim 1, wherein the image overlay module is further executable to generate display of at least one browsing overlay button.

12. The imaging system of claim 11, wherein the at least one browsing overlay button is configured to enable at least one of selection of a menu option or navigation of a browsable list.

13. A method, comprising:
receiving a moving image of a body;
generating a left image overlay and a right image overlay;
generating display of the received image of the body on a display device;
generating display of the left image overlay and the right image overlay at a predetermined location on the display device;
detecting alignment of a location of a first portion of the image of the body with the left image overlay and a location of a second portion of the image of the body with the right image overlay after a predetermined amount of time; and
establishing at least one reference location on the captured image of the body corresponding to at least one of the location of the first portion of the image of the body or the location of the second portion of the image of the body.

14. The method of claim 13, further comprising recognizing the first portion of the image of the body is a left hand of the body and the second portion of the image of the body is the right hand of the body.

15. The method of claim 13, further comprising generating a notification in response to at least one reference location being established.

16. The method of claim 13, further comprising analyzing the received image of the body to obtain at least one attribute associated with the image of the body.

17. A tangible computer-readable media comprising a plurality of instructions for execution with a processor, the tangible computer-readable medium comprising:
instructions executable to receive a moving image of a body;
instructions executable to generate a left image overlay and a right image overlay;
instructions executable to generate display of the received moving image of the body on a display device;
instructions executable to generate display of the left image overlay and the right image overlay at a predetermined location on the display device in conjunction with the moving image of the body;
instructions executable to detect alignment of a location of a first portion of the image of the body with the left image overlay and a location of a second portion of the image of the body with the right image overlay after a predetermined amount of time; and
instructions executable to establish at least one reference location on the received moving image of the body corresponding to at least one of the location of the first portion of the image of the body or the location of the second portion of the image of the body.

18. The one or more tangible computer-readable media of claim 17, further comprising instructions executable to recognize the first portion of the image of the body is a left hand of the body and the second portion of the image of the body is the right hand of the body.

19. The one or more tangible computer-readable media of claim 17, further comprising instructions executable to generate a notification in response to at least one reference location being established.

20. The one or more tangible computer-readable media of claim 17, further comprising instructions executable to analyze the captured image of the body to obtain at least one attribute associated with the image of the body.
